(19) United States
(12) Patent Application Publication
(10) Pub. No.: US 2018/0150990 A1
(43) Pub. Date: May 31, 2018

(54) ANIMATION DISPLAY APPARATUS AND ANIMATION DISPLAY METHOD

(71) Applicant: Mitsubishi Electric Corporation, Tokyo (JP)

(72) Inventor: Takumi AKIYAMA, Tokyo (JP)

(73) Assignee: Mitsubishi Electric Corporation, Tokyo (JP)

(21) Appl. No.: 15/572,271

(22) PCT Filed: Jul. 17, 2015
(86) PCT No.: PCT/JP2015/070491

§ 371 Date: Nov. 7, 2017

(51) Int. Cl. G06T 13/80; G06T 11/00

(52) U.S. Cl. CPC G06T 13/80; G06T 2213/12; G06T 11/001

(57) ABSTRACT

It is an object of the invention to provide an animation display apparatus that displays an animation, and that prevents the user from having an odd feeling. When drawing animation components in a frame, the animation display apparatus and the animation display method according to the present invention determine whether or not to use attribute information about color, and draw animation components for which an attribute about color is determined not to be used, without using the attribute information about color, thereby reducing the throughput of the CPU.

### TECHNICAL FIELD

The present invention relates to an animation display apparatus for and an animation display method of displaying an animation.

### BACKGROUND ART

In graphical user interfaces (GUIs), to display information on a screen, animation display in which animation components, such as images and graphics, are used and displayed by changing their positions, their shapes, their colors, etc., on the screen is performed. To play back animations visually smoothly, a display speed which is a frame rate is required, for example, 30 frames are displayed per second. When animation components are drawn in each frame, a large throughput of a central processing unit (CPU) is required for a frame in which a complicated animation is drawn, e.g., in which many animation components are included. Because a longer processing time is required when the throughput is large, there is a case in which the drawing is not completed by the display time set to the frame. As a result, a problem is that because the display of the entire animation is not completed within an originally-set display time period and is not smooth visually, there is a case in which the animation provides the user with an odd feeling.

As a technique for solving this problem, there is provided an animation display method disclosed in Patent Literature 1. Patent Literature 1 discloses a method of, in a method of keyframing which creates intermediate frames by supplementing information between key frames on the basis of information about key frames in each of which the shapes and the positions of objects are specified at several frames intervals, thinning out one or more frames to complete the display of an animation by a predetermined animation display time. When there is a point of inflection in the movement locus of an animation component having a motion in frames, it is desirable to set a frame including this point of inflection as a key frame in order to display the animation as intended. When such an animation is displayed, unless a key frame corresponding to a point of inflection in the movement locus of an animation component is drawn, the display of the animation greatly differs from an intended animation display. According to the method disclosed in Patent Literature 1, in order to prevent the display of an animation from greatly differing from an intended animation display, by performing a control operation of thinning out an intermediate frame without displaying this frame when the intermediate frame cannot be displayed at a predetermined time, and certainly displaying each key frame at the time when the key frame is to be displayed on the screen, the shape of the locus of the animation is prevented from being greatly deviated.

### CITATION LIST

### Patent Literature

Patent Literature 1: International Publication No. 2011/158446

### SUMMARY OF INVENTION

### Technical Problem

Although because the above-mentioned method is the one of preventing the shape of the locus of an animation from greatly deviating from the original one by certainly displaying each key frame at a predetermined time, but thinning out some intermediate frames, the frame rate of the animation displayed is decreased. A problem with this display of an animation in which the frame rate is decreased is that the display of the animation causes the user to have an odd feeling.

The present invention is made in order to solve the above-mentioned problem, and it is therefore an object of the present invention to provide an animation display apparatus that prevents the user from having an odd feeling.

### Solution to Problem

An animation display apparatus according to the present invention includes: an attribute storage unit for storing pieces of attribute information about animation components that configure an animation; a group information storage unit for storing group information showing a correspondence between groups to one of which each animation component belongs and the animation components; a specifying unit for specifying a frame in which the animation component information is to be drawn; a drawing attribute determining unit for, when the animation components are drawn in the frame specified by the specifying unit, determining whether or not to use attribute information about color for each group of the group information stored in the croup information storage unit; and an animation drawing unit for drawing an animation component that belongs to a group for which an attribute about color is determined not to be used by the drawing attribute determining unit, using attribute information except the attribute about color.

Further, an animation display method according to the present invention includes: an attribute storing step of storing pieces of attribute information about animation components that configure an animation; a group information storing step of storing group information showing a correspondence between groups to one of which each of the animation components belongs and the animation components; a specifying step of specifying a frame in which the animation component information is to be drawn; a drawing attribute determining step of, when the animation components are drawn in the frame specified in the specifying step, determining whether or not to use attribute information about color for each group of the group information stored in the croup information storing step; and an animation drawing step of drawing an animation component that belongs to a group for which an attribute about color is determined not to be used in the drawing attribute determining step, using attribute information except the attribute about color.

### Advantageous Effects of Invention

According to the present invention, because when animation components are drawn in a frame, it is determined whether or not to use attribute information about color, and an animation component for which an attribute about color is determined not to be used is drawn without using the attribute information about color, the throughput of a CPU can be reduced.

### BRIEF DESCRIPTION OF DRAWINGS

FIG. 1 illustrates diagrams schematically showing pieces of key frame information according to Embodiment 1, in which FIG. 1A is an explanatory drawing of a start key frame and FIG. 1B is an explanatory drawing of an end key frame;

FIG. 2 is a block diagram showing the configuration of an animation display apparatus according to Embodiment 1;

FIG. 3 is a flow chart showing a drawing operation performed by the animation display apparatus according to Embodiment 1;

FIG. 4 is a detailed flowchart showing an operation of drawing intermediate frames which is performed by the animation display apparatus according to Embodiment 1;

FIG. 5 is a detailed flowchart showing an operation of drawing intermediate frames at a time of performing grouping in accordance with positions on a screen which is performed by an animation display apparatus according to Embodiment 2;

FIG. 6 is a detailed flowchart showing an operation of drawing intermediate frames at a time of performing grouping in accordance with indexes for the screen which is performed by the animation display apparatus according to Embodiment 2; and

FIG. 7 is a hardware block diagram of the animation display apparatus according to Embodiment 1.

### DESCRIPTION OF EMBODIMENTS

### Embodiment 1

Hereafter, an animation display apparatus according to Embodiment 1 of the present invention will be explained. In this embodiment, an animation display apparatus that uses keyframing will be explained.

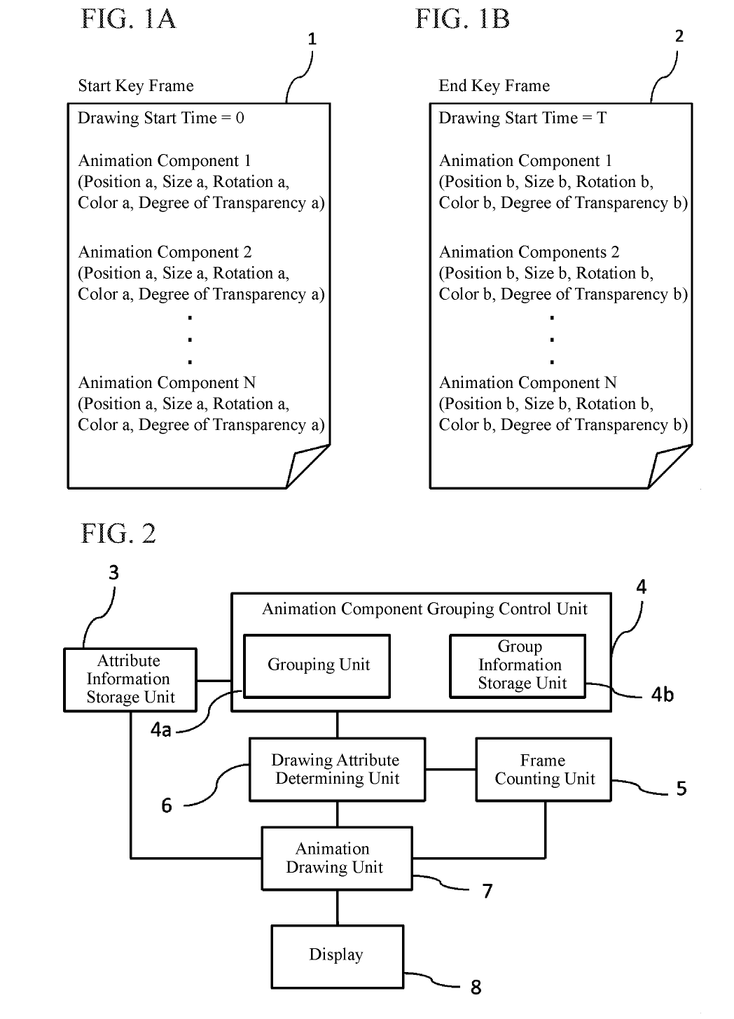

In keyframing, an entire animation is displayed by setting key frame information specifying the shapes and the positions of objects for every several frames, supplementing information between key frames to generate intermediate frames, and displaying the key frames and the intermediate frames. Key frames will be explained hereafter. FIG. 1 illustrates diagrams conceptually showing pieces of key frame information according to Embodiment 1 in each of which pieces of attribute information about animation components included in a key frame are defined, and FIG. 1A shows key frame information 1 about a start key frame and FIG. 1B shows key frame information 2 about an end key frame. Key frame information contains definition information about attributes including the positions and colors of animation components, such as characters and graphics that configure an animation. Two or more key frames exist during a time period from the execution of an animation until the animation is ended, and, between key frames, intermediate frames generated from the key frames exist. In this embodiment, in an animation to be executed, an n-th key frame is referred to as a start key frame, and the following key frame, (n+1)-th key frame, is referred to as an end key frame.

Key frame information contains information about a drawing start time to start a drawing of the key frame. For example, in a case in which the time at which drawing of a start key frame is to be started is set to be drawing start time 0, and the time at which drawing of an end key frame is to be started is set to be drawing start time T, the drawing of the start key frame is started at time 0 and the drawing of the end key frame is started at drawing time T. Therefore, in this case, an animation having a time period of T is defined.

For intermediate frames other than the start key frame and end key frame, the definition information about each animation component is read from the pieces of key frame information 1 and 2 about the start key frame and end key frame, and the read pieces of definition information are supplemented to generate information about animation components of intermediate frames. Then, by drawing the start key frame, the end key frame and the generated intermediate frames by using the pieces of information about those frames, the animation over a time period of T is displayed. The number of frames displayed per unit time is called a frame rate. The number of intermediate frames to be interpolated is determined in accordance with both the time period of T and the frame rate which is determined for each animation. The frame rate is set for each animation, and can be set in advance by an animation creator or can be specified from outside the display apparatus. The larger number of frames are displayed during the time period of T, the more smoothly the animation appears to move. However, the throughput of drawing which the animation display apparatus performs also increases with increase in the number of frames.

As explained above, key frame information contains information about animation components. Animation components are individual elements, such as characters, graphics and images, which are to be drawn in a frame. Each animation component has, as attributes, definition information about position, size, rotation, color and degree of transparency. These attributes express how each animation component is displayed in drawing the first frame, intermediate frames and the last frame. The descriptions of the attributes are specified by software or an animation creator. Definition information about attributes other than position, size, rotation, color and degree of transparency may be included. Part of the definition information, such as only a position attribute, may be defined. On the basis of the pieces of definition information about the attributes of the animation components which each of the key frames has, pieces of information about intermediate frames between the start key frame and the end key frame are generated by using a method which will be mentioned below, and are provided for drawing of the intermediate frames.

FIG. 2 is a block diagram showing the configuration of the animation display apparatus according to Embodiment 1 of the present invention. The animation display apparatus includes: an attribute information storage unit 3 for storing pieces of attribute information about animation components; an animation component grouping control unit 4 provided with a grouping unit 4a for grouping the animation components and a group information storage unit 4b for storing pieces of group information about the animation components; a frame counting unit 5 serving as a specifying unit for specifying a frame for which animation component information is to be drawn; a drawing image attribute determining unit for determining whether or not to perform drawing about color or degree of transparency for each animation component group; an animation drawing unit 7 for drawing animation components; and a display 8 for displaying frames drawn.

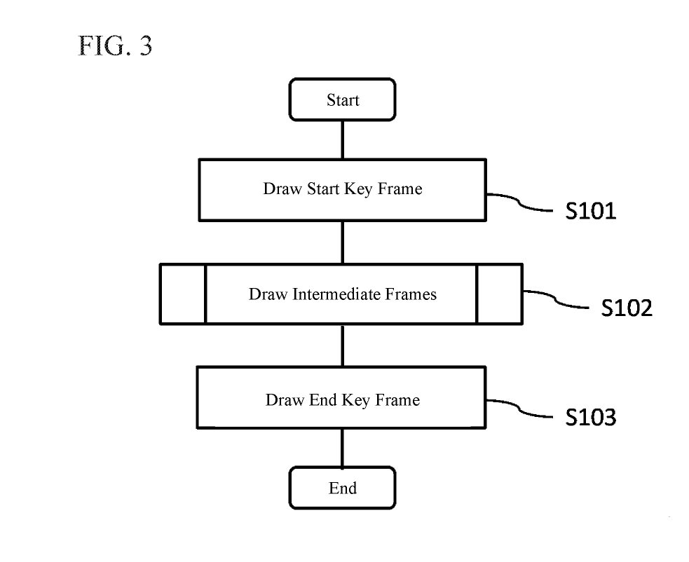

The animation display apparatus having the above-mentioned configuration draws each frame which configures the animation in accordance with the flow chart shown in FIG. 3, and displays the animation on the display 8. The pieces of key frame information 1 and 2 about the start key frame and the end key frame are stored in the attribute information storage unit 3, and the start key frame is drawn first, in step S101, by the animation drawing unit 7 on the basis of the key frame information 1 stored in the attribute information storage unit 3. Next, in step S102, on the basis of the pieces of key frame information 1 and 2 about the start key frame and the end key frame stored in the attribute information storage unit 3, pieces of animation component information about intermediate frames are generated, and the intermediate frames are drawn by the animation drawing unit 7 on the basis of the generated pieces of animation component information. This generation of pieces of animation component information about intermediate frames is performed by the animation component grouping control unit 4, the drawing attribute determining unit 6, the frame counting unit 5 and the animation drawing unit 7, and the details of the operation will be explained below. Finally, in step S103, the end key frame is drawn on the basis of the key frame information 2.

A more detailed configuration of the animation display apparatus explained above will be explained below. In the attribute information storage unit 3 shown in FIG. 2, pieces of key frame information for displaying the animation containing the start key frame and the end key frame are stored.

The animation component grouping control unit 4 includes the grouping unit 4a and the group information storage unit 4b. The grouping unit 4a extracts animation components that have attributes about color and degree of transparency from among the pieces of animation component information included in the pieces of key frame information 1 and 2 about the start key frame and the end key frame, and groups the extracted animation components into three groups randomly. The group information storage unit 4b then stores a result of the grouping. The grouping is performed to distribute the load imposed on the process of drawing the animation components in each frame, and it is desirable for the purpose of distribution of the drawing process that the numbers of components sorted into each group are balanced. The number of groups is not limited to three, and it may be two or more. Further, the grouping is not necessarily performed randomly, but may be performed in accordance with a certain rule.

The frame counting unit 5 counts the number of intermediate frames to be displayed between the start key frame and the end key frame, and assigns a frame number to each of the intermediate frames. Further, when an inquiry about a frame to be drawn from now on from the drawing attribute determining unit 6 is received, the frame number of the frame is outputted.

When each animation component is drawn in the intermediate frame specified by the frame counting unit 5, the drawing attribute determining unit 6 determines whether or not to use the attributes about color and degree of transparency for each of the groups into which the animation components are grouped by the animation component grouping control unit 4.

The animation drawing unit 7 draws each animation component on the frame specified by the frame counting unit 5 on the basis of a result of the determination performed by the drawing attribute determining unit 6. Each animation component in a group of animation components for which a determination is made to use the attributes about color and degree of transparency is drawn on the frame by using the attributes about position, size, rotation, color and degree of transparency which are all the attributes of the animation component in the group. Each animation component in a group of animation components for which a determination is made not to use the attributes about color and degree of transparency is drawn on the frame by using the attributes about only position, size and rotation which are the attributes excluding the attributes about color and degree of transparency of the animation component in the group. Drawing without using the attributes about color and degree of transparency means to draw using the attribute values of color and degree of transparency of the immediately preceding frame, at a time of drawing each intermediate frame to be interpolated, without updating the attribute values of color and degree of transparency of the immediately preceding frame.

When drawing each key frame, in order to prevent the shape of the locus of the animation from being greatly deviated, a drawing is started at each of the drawing start times set in the pieces of key frame information 1 and 2, and the animation components in all the groups are drawn by using the attributes about position, size, rotation, color and degree of transparency which are all the attributes. As a result, the start key frame and the end key frame can be displayed, reflecting all the defined attribute values of the pieces of definition information in each of the key frames.

The display 8 includes a display control unit, and a display apparatus unit made of material, such as liquid crystal, and displays frames drawn by the animation drawing unit 7 on the display apparatus unit at a fixed frame rate under display control by the display control unit. As a result, a series of animation images is displayed on the display apparatus unit.

Next, operations of the animation display apparatus according to this embodiment will be explained. As mentioned above, FIG. 3 is a flow chart showing the drawing operation of the animation display apparatus according to Embodiment 1.

First, in step S101, the animation drawing unit 7 acquires the key frame information 1 about the start key frame from the attribute information storage unit 3, and draws the start key frame on the basis of the key frame information 1. For the purpose of drawing and displaying the start key frame that reflects all the attribute values defined for animation, the start key frame is drawn using all the attributes of the animation components.

Then, in step S102, pieces of information about intermediate frames are generated from the pieces of key frame information 1 and 2 about the start key frame and the end key frame, the pieces of key frame information being stored in the attribute information storage unit 3, and the intermediate frames are drawn on the basis of the generated pieces of information about the intermediate frames.

To this end, the animation component grouping control unit 4 acquires pieces of animation component information from the pieces of key frame information 1 and 2 about the start key frame and the end key frame, the pieces of key frame information being stored in the attribute information storage unit 3, first, extracts animation components that have attribute information about color and degree of transparency from among the pieces of animation component information, and groups the extracted animation components. A result of the grouping, i.e., group information showing a correspondence between groups to one of which each of the animation components belongs and the animation components is stored in the group information storage unit 4b.

Next, the drawing attribute determining unit 6 inquires of the frame counting unit 5 about the frame which is to be drawn from now on, and determines, as to each of the animation components included in the frame which is to be drawn from now on, whether or not to use the information about color and degree of transparency in the frame for each of the groups into which the animation components are grouped, while referring to the group information stored in the group information storage unit 4b. Finally, the animation drawing unit 7 draws the frame specified by the frame counting unit 5 on the basis of the determination performed by the drawing determining unit.

The drawing of the intermediate frames in step S102 is performed in this way. The details of the method of drawing the intermediate frames will be mentioned below.

Finally, in step S103, the end key frame is drawn. To draw and display the end key frame that reflects all the attribute values defined in the key frame information 2 like the start key frame, the animation drawing unit draws the end key frame by using all the attributes of the animation components.

All the frames which configure the animation are drawn in accordance with the flowchart of steps S101 to S103. Every time a frame is drawn, the frame is outputted to the display 8 and is displayed at the frame rate determined by software or the like, so that the animation is displayed.

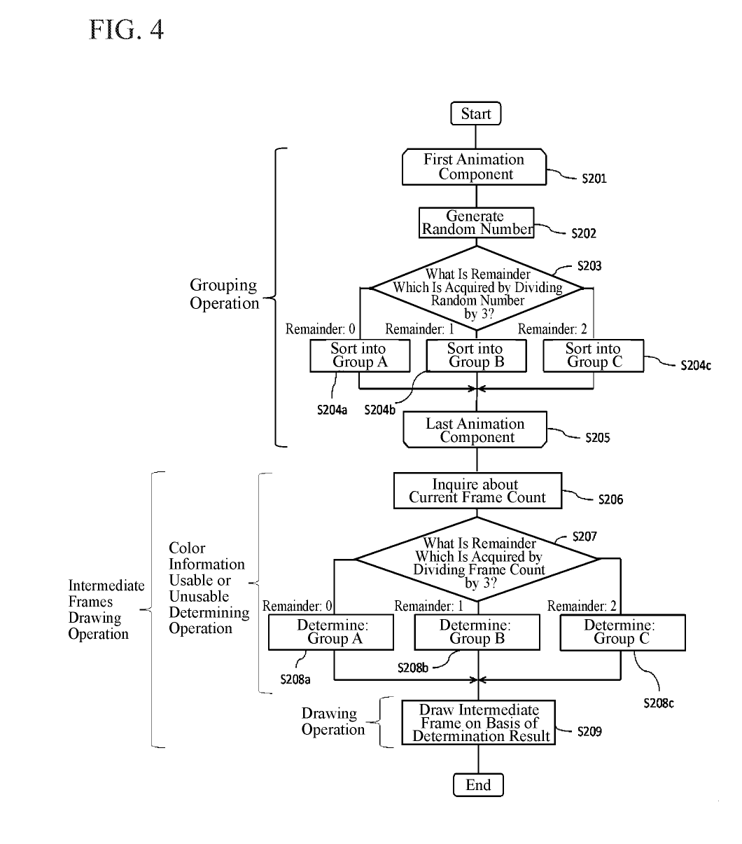

Next, details of the operation of drawing the intermediate frames will be explained. FIG. 4 is a detailed flowchart showing the operation of drawing the intermediate frames of the animation display apparatus according to this embodiment.

The animation component grouping control unit 4 performs grouping operations of steps S201 to S205. Animation components having attribute information about color and degree of transparency are grouped by the animation grouping control unit. Grouping of animation components not having attribute information about color and degree of transparency is not performed.

First, in step S201, a first animation component is selected. Next, in step S202, a random number is generated for the animation component. Then, in step S203, the random number, which is generated for the animation component, is divided by 3, and, if the remainder is 0, the process advances to step S204a and the target animation component is made to belong to group A, if the remainder is 1, the process advances to step S204b and the target animation component is made to belong to group B, and if the remainder is 2, the process advances to step S204c and the target animation component is made to belong to group C. The above-described operations from steps S201 to S205 are repeated on up to a last animation component, and all the animation components having attribute information about color and degree of transparency are sorted into the three groups. As a result, each animation component having attribute information about color and degree of transparency can be made to belong to one of the three groups at random. A result of the grouping, i.e., group information showing a correspondence between the groups to one of which each of the animation components belongs and the animation components is stored in the group information storage unit 4b.

Next, the drawing attribute determining unit 6, the animation drawing unit 7 and the display 8 perform an intermediate frames drawing operation of steps S206 to S209. In the intermediate frames drawing operation, the drawing attribute determining unit 6 performs a color information usable or unusable determining operation of steps S206 to S208 first. The drawing attribute determining unit 6 inquires of the frame counting unit 5 about what number frame is to be drawn from now on, and determines whether or not to use the attribute information about color and degree of transparency in drawing for each group into which animation components are grouped by the animation component grouping control unit 4.

First, the drawing attribute determining unit 6, in step S206, inquires of the frame counting unit 5 about what number frame is to be drawn from now on. Next, in step S207, the numerical value the drawing attribute determining unit has obtained from the frame counting unit 5 by inquiring, i.e., the frame number is divided by 3. If the result of the division process of step S207 shows that the remainder is 0, the process advances to step S208a and group A is determined to be a group for which the attributes about color and degree of transparency is used, if the remainder is 1, the process advances to step S208b and group B is determined to be a group for which the attributes about color and degree of transparency is used, and if the remainder is 2, the process advances to step S208c and group C is determined to be a group for which the attributes about color and degree of transparency is used. Through this operation, for frames which are to be drawn from now on, which group of animation components is to be drawn using the attributes about color and degree of transparency can be determined.

Next, the animation drawing unit 7 performs a drawing operation of step S209. The animation drawing unit 7 draws each animation component on the frame which is to be drawn from now on the basis of the result of the determination which is performed by the drawing attribute determining unit 6. If the result of the determination shows that group A is a group for which the attributes about color and degree of transparency is used, each of the animation components which are made to belong to group A is drawn on the frame by using all the attributes: position, size, rotation, color and degree of transparency. Further, each of the animation components which are made to belong to group B or C is drawn on the frame by using the attributes about position, size and rotation other than color and degree of transparency. As the attributes about color and degree of transparency of each of the animation components which are made to belong to group B or C, the attribute values of the immediately preceding frame are maintained. Further, because the animation components which are not grouped into any group do not have attribute information about color and degree of transparency, each of the animation components is drawn on the frame by using all the attributes which the animation component has.

By performing the intermediate frame drawing operation shown in above steps S206 to S209 on a plurality of intermediate frames, the drawing of the intermediate frames of step S102 of FIG. 3 is performed. The series of operations including this drawing of the intermediate frames, and associated with the drawing and the display of the entire animation as shown in FIG. 3 are thus completed.

In drawing of an animation component, the drawing process using the attribute information about color and degree of transparency imposes a high load on the CPU. As described above, in drawing of a frame, by setting a group of animation components which does not use attribute information about color and degree of transparency, the throughput of the drawing can be reduced. The group on which attribute information about color and degree of transparency is used depends on the frame number. Therefore, some animation components are not updated in the display of color and degree of transparency for several frames, but the display of color and degree of transparency is updated at intervals of several frames.

Although there is a case in which the image drawn through the above-described drawing operation has a discontinuity in both a change in color and a change in degree of transparency, the user can be prevented from having an odd feeling in the animation even if there is a discontinuity in a change in color because human beings cannot easily perceive a change in color and a change in degree of transparency in the animation.

Note that since translation, enlargement and reduction, and rotation of animation is performed on all components for all frames, a phenomenon in which, for example, two components to be drawn at the same position are displayed misaligned can be prevented from occurring.

Because through the above-explained operations, animation components are grouped and both a group of animation components which is to be drawn by using the attributes about color and degree of transparency and a group of animation components which is to be drawn without using the attributes about color and degree of transparency are set, the load on the CPU can be reduced when the animation drawing unit 7 draws animation components in each of the intermediate frames.

### Embodiment 2

Next, an animation display apparatus according to Embodiment 2 of the present invention will be explained. A grouping method according to Embodiment 2 differs from that according to Embodiment 1, while the others are the same as that according to Embodiment 1. In Embodiment 1, animation components are grouped on the basis of generated random numbers. In contrast, in Embodiment 2, grouping is performed on each of animation components on the basis of the position of the animation component on an animation screen.

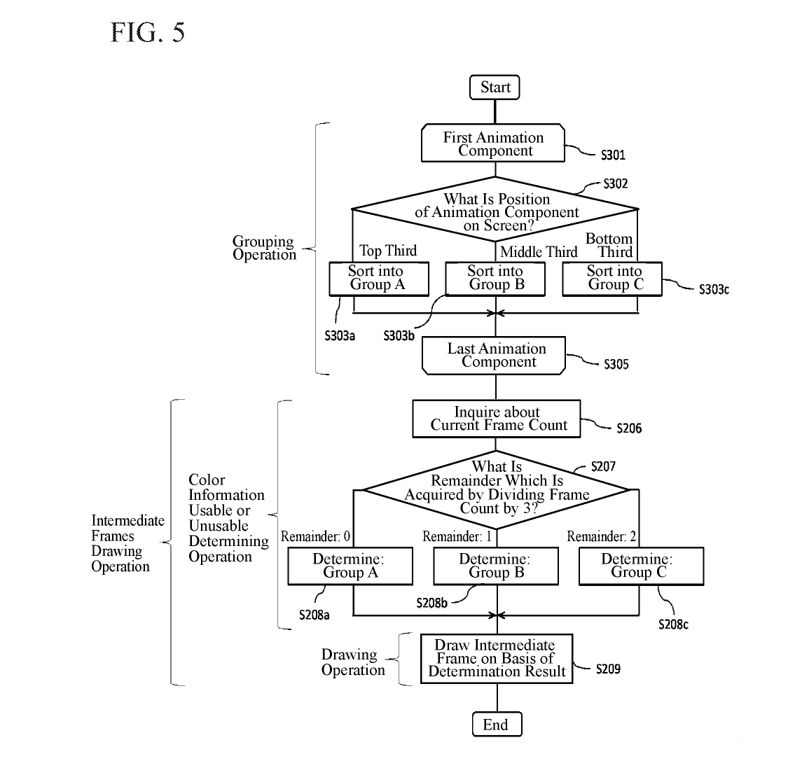

FIG. 5 is a detailed flowchart of an operation of drawing intermediate frames in the animation display apparatus according to Embodiment 2. In Embodiment 2, the operations from steps S201 to S205 of Embodiment 1 are changed to operations from steps S301 to S305. In step S301, a first animation component is selected. Next, in step S302, grouping is performed on the animation component in accordance with where on the screen the position coordinates of the upper left corner of the animation component are to be displayed. If the position coordinates are in a top third area of the screen, the process advances to step S303a and the target animation component is made to belong to group A, if the position coordinates are in a middle third area of the screen, the process advances to step S303b and the target animation component is made to belong to group B, and if the position coordinates are in a bottom third area of the screen, the process advances to step S303c and the target animation component is made to belong to group C.

The above-described operations from steps S301 to S305 are performed on up to a last animation component, and all the animation components each having attribute information about color and degree of transparency are divided into the three groups. As a result, animation components having attribute information about color and degree of transparency can be sorted into one of the three groups by area in the screen. A result of the grouping, i.e., group information showing a correspondence between the groups to one of which each of the animation components belongs and the animation components, is stored in a group information storage unit 4b.

Intermediate frame drawing operations subsequent to the grouping are the same as those according to Embodiment 1.

The grouping of animation components in accordance with the positions of the animation components on the screen is not limited to the above-described method. As an alternative, animation components may be divided into two groups according to right and left of the screen, or the screen may be divided into tiles and animation components may be sorted into groups according to which of the tiles each animation component is positioned on.

As mentioned above, in the animation display apparatus according to Embodiment 2, the animation component grouping unit 4 performs grouping on animation components in accordance with the position on the screen at which each animation component is to be drawn. More specifically, when an animation is displayed on a display apparatus of a display 8, animation components which are located close to each other belong to the same group. Therefore, when an animation is displayed, if two components which should have the same color or the same degree of transparency in an intermediate frame are close to each other, the two components are displayed with the same color or the same degree of transparency. Further, when two animation components are far away from each other, the components are made to belong to different groups, but the user can be prevented from having an odd feeling because the animation components are displayed apart from each other. Further, because a range within which animation components are drawn in one frame is concentrated into a specific area, the load on the CPU at the time of drawing the animation can be minimized.

### Embodiment 3

Next, an animation display apparatus according to Embodiment 3 of the present invention will be explained. A grouping method according to Embodiment 3 differs from those according to Embodiments 1 and 2, while the others are the same as that according to Embodiment 1. In Embodiment 3 an index number is provided for each of animation components and grouping is performed on the basis of this index number, unlike those according to Embodiments 1 and 2.

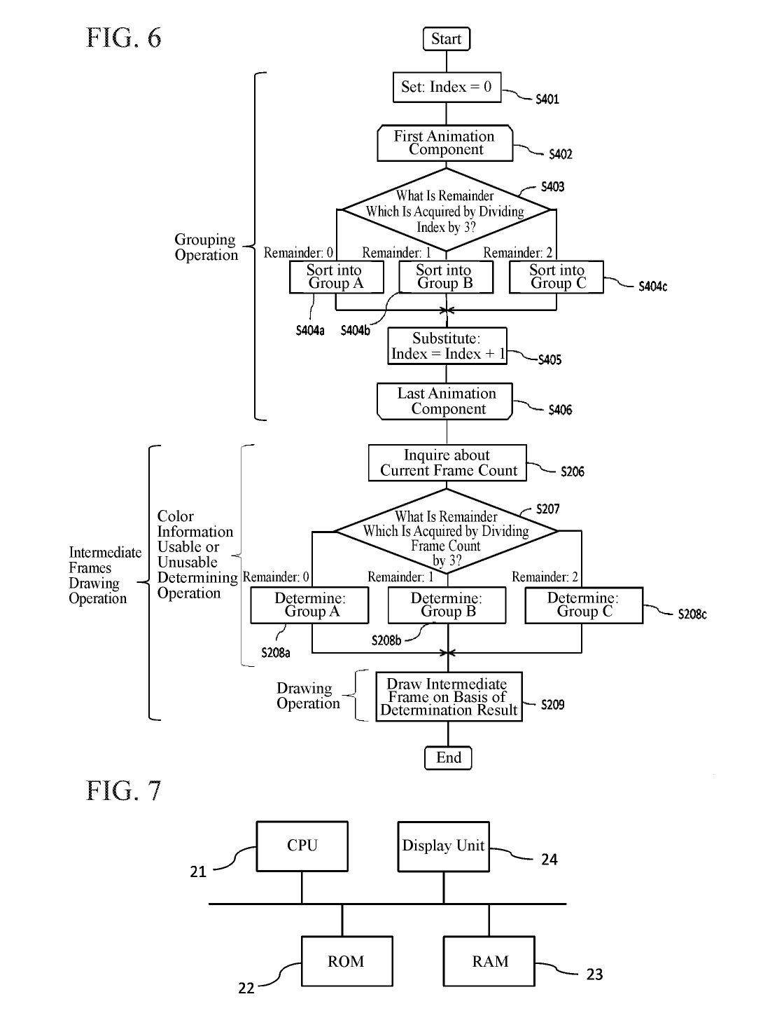

FIG. 6 is a detailed flowchart showing an operation of drawing intermediate frames which is performed by the animation display apparatus according to this embodiment. In Embodiment 3, operations from steps S201 to S205 of Embodiment 1 are changed to operations from steps S401 to S406.

First, in step S401, a grouping unit 4b initializes the index number; it initializes index to zero (index=0). Next, in step S402, a first animation component is selected, and 0 is assigned as an index to the selected animation component. Next, in step S403, the numerical value of the index of the animation component is divided by 3, and if the remainder is 0, the process advances to step S404a and the target animation component is made to belong to group A, if the remainder is 1, the process advances to step S404b and the target animation component is made to belong to group B, and if the remainder is 2, the process advances to step S404c and the target animation component is made to belong to group C. When the sort in steps S404a to S404c is completed, the index number is incremented in step S405, so that index=index+1. The above-described operations from steps S401 to S406 are repeatedly performed on up to a last animation component, and all the animation components each having attribute information about color and degree of transparency are divided into the three groups. A result of the grouping, i.e., group information showing a correspondence between the groups to one of which each of the animation components belongs and the animation components, is stored in a group information storage unit 4b.

Intermediate frame drawing operations subsequent to the grouping are the same as those according to Embodiment 1.

As described above, in the animation display apparatus according to Embodiment 3, an animation component grouping unit 4 groups the animation components on the basis of index numbers assigned to the animation components. More specifically, the animation components are made to belong to groups in order. According to this grouping methodology, the numbers of animation components that are sorted into each group are substantially equalized. According to the grouping using random numbers as shown in Embodiment 1, the number of animation components can be spread over the groups in a probabilistic manner, or the order in which the animation components are read can be spread over the groups in a probabilistic manner. In contrast, by performing grouping as shown in this Embodiment 3, spreading of the number of animation components over the groups can be performed surely, and a contribution can be made to the load on the CPU when drawing an animation.

The number of groups at the time of performing grouping is not limited to three, and can be any number as long as the number of groups is a plural number such as two or four. Being balanced in the number of animation components or in the sizes of animation components among the groups after grouping spreads the load on the CPU.

In Embodiments 1 to 3, the drawing attribute determining unit 6 determines whether or not to use the attributes about color and degree of transparency when drawing animation components. Because human beings cannot easily perceive a change in colors among the attributes of an animation, an animation which makes it difficult for the user to have an odd feeling can be acquired even if the processes on the attribute about a color are thinned. In the above-described embodiments, although the example in which the attributes about both color and degree of transparency are set as the attributes which the drawing attribute determining unit 6 does not use for drawing is explained, an attribute about either only color or only degree of transparency may be set as the attribute that is not used by the drawing attribute determining unit for drawing. Because the degree of transparency shows to what degree of lightness or darkness a color is set, a degree of transparency is one attribute about color. Another parameter other than color and degree of transparency may be considered as long as it relates to the attribute about color.

In Embodiments 1 to 3, the grouping unit 4a performs grouping on animation components and information about this grouping is used. As an alternative, information which is generated in advance may be stored in the group information storage unit 4b, and this group information may be referred to when drawing. In this case, the animation component grouping control unit 4 can be configured so as not to include the grouping unit 4a.

Further, although in Embodiments 1 to 3, the animation displaying method which uses the keyframing has been explained, the present invention can be used for a graphics animation format in which an animation is configured in units of a frame.

Because when drawing animation components in a frame, the animation display apparatus according to the present invention determines whether or not to use attribute information about color, and draws an animation component for which the animation display apparatus determines not to use the attribute information without using the attribute information about color, the throughput of the CPU can be reduced.

The animation display apparatus according to the present invention can also be implemented by a configuration as shown in FIG. 7. The attribute information storage unit 3, the animation component grouping control unit 4, the drawing attribute determining unit 6, the frame counting unit 5, the animation drawing unit 7 and the display 8 in this case can be implemented by executing a program stored in a ROM 22, and storing or reading each information in or from a RAM 23, to display the information on a display unit 24, by means of a CPU 21. At this time, the animation display apparatus stores the pieces of key frame information 1 and 2 about the start key frame and the end key frame in the RAM 23 corresponding to the attribute information storage unit 3, the program for performing the operations shown in the flow charts of FIGS. 3, 4, 5 and 6 is stored in the ROM 22, and the CPU 21 executes this program.

### REFERENCE SIGNS LIST

1 key frame information about a start key frame, 2 key frame information about an end key frame, 3 attribute information storage unit, 4 animation component grouping control unit, 4a grouping unit, 4b group information storage unit, 5 drawing attribute determining unit, 6 frame counting unit, 7 animation drawing unit, 8 display, 21 CPU, 22 ROM, 23 RAM, and 24 display unit.

1. An animation display apparatus comprising:
a processor to execute a program; and
a memory to store the program which, when executed by the processor, performs processes of:
storing pieces of attribute information about animation components that configure an animation;
storing group information showing a correspondence between groups to one of which each animation component belongs and the animation components;
specifying a frame in which the animation component information is to be drawn;
determining, when the animation components are drawn in the specified frame, whether or not to use attribute information about color for each group of the stored group information; and
drawing an animation component that belongs to a group for which an attribute about color is determined not to be used, using an attribute about color of an animation component that is drawn one frame before.

2. The animation display apparatus according to claim 1, wherein the processor is further configured to perform grouping of the animation components.

3. The animation display apparatus according to claim 2, wherein the pieces of animation component information are grouped at random by the processor.

4. The animation display apparatus according to claim 2, wherein the pieces of animation component information are grouped by the processor according to position on a screen on which the animation is displayed.

5. The animation display apparatus according to claim 2, wherein the pieces of animation component information are grouped by the processor by assigning an index to each animation component.

6. An animation display method comprising:
an attribute storing step of storing pieces of attribute information about animation components that configure an animation;
a group information storing step of storing group information showing a correspondence between groups to one of which each of the animation components belongs and the animation components;
a specifying step of specifying a frame in which the animation component information is to be drawn;
a drawing attribute determining step of, when the animation components are drawn in the frame specified in the specifying step, determining whether or not to use attribute information about color for each group of the group information stored in the group information storing step; and
an animation drawing step of drawing an animation component that belongs to a group for which an attribute about color is determined not to be used in the drawing attribute determining step, using an attribute about color of an animation component that is drawn one frame before.
